(19) United States
(12) Patent Application Publication
(10) Pub. No.: US 2013/0265297 A1
(43) Pub. Date: Oct. 10, 2013

(54) Display of a Corrected Browser Projection of a Visual Guide for Placing a Three Dimensional Object in a Browser

(71) Applicant: Eric J. Mueller, Los Gatos, CA (US)

(72) Inventor: Eric J. Mueller, Los Gatos, CA (US)

(73) Assignee: Motorola Mobility, Inc., Libertyville, IL (US)

(21) Appl. No.: 13/441,360

(22) Filed: Apr. 6, 2012

(51) Int. Cl. G06T 15/00

(52) U.S. Cl. 345/419

(57) ABSTRACT

A method for displaying a corrected projection of a visual guide for a 3D object includes receiving drawing information for displaying the 3D object in a browser, and displaying, in the browser, a first visual guide having a first projection for the 3D object for a default 3D location. The first projection is a default projection of the browser. The method further includes un-projecting the first visual guide to reverse the first projection of the browser. The un-projected first visual guide is a second visual guide for the 3D object. The method further includes projecting the second visual guide according to an actual 3D location of the 3D object in the computerized 3D space. The method further includes displaying, in the browser, the second visual guide at the actual 3D location at which the 3D drawing will appear subsequent to displaying the 3D object in the browser.

### BACKGROUND

Particular embodiments generally relate to three-dimensional (3D) authoring tools.

Proprietary three-dimensional (3D) authoring tools allow a user to create and display 3D objects on a display. The proprietary authoring tools allow users to place objects into a 3D environment. For example, when the user creates a 3D object, the 3D object can be placed into a computerized 3D space with other 3D objects. No transform and/or projection operations are needed to place the 3D object into the 3D environment and the 3D object appears at the location at which the 3D object is placed by the user. For example, a cursor may be positioned over the 3D object, and the 3D object may be placed in the computerized 3D space at the position the cursor is moved to. That is, the 3D object does not shift to a different location from where the cursor for the 3D object is placed.

A web browser is a platform independent application that can be used for creating and displaying 3D objects in a 3D computerized environment. However, the web browser projects individual 3D objects according to a default projection. The default projection projects individual 3D objects as though the center of each 3D object lies in a specific plane, typically the X-Y plane. If a center of a 3D object is not in the specific plane for the default projection, then the 3D object will not be properly projected by the web browser. For example, if a center of a 3D object is in front of the specific plane, the default projection of the web browser causes the 3D object to appear larger than it should. Similarly, if a 3D object is behind the specific plane, the default projection of the web browser causes the 3D object to appear smaller than it should. Further, the user placement of the 3D object projected by a web browser may be difficult because the 3D object may shift from a location at which the user has placed a visual guide, placed a cursor, or the like for placing the 3D object.

### BRIEF DESCRIPTION OF THE DRAWINGS

FIG. 1 depicts an example of a computing device for displaying 3D objects according to one embodiment.

FIG. 2 depicts a computerized 3D space displayed in a browser according to one embodiment.

FIG. 3 depicts a simplified flowchart of a method for creating and displaying an actual visual guide for a 3D object according to one embodiment.

### DETAILED DESCRIPTION

Described herein are techniques for displaying a corrected browser projection of a visual guide for placing a three dimensional (3D) object displayed by a browser in a browser environment. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

In one embodiment, a method for displaying a corrected browser projection of a visual guide for placing a of a three dimensional (3D) object displayed by a browser includes receiving, via the computing device, drawing information for displaying the 3D object in the browser, and displaying, in the browser, a first visual guide having a first projection for the 3D object for a default 3D location in a computerized 3D space in response to receiving the drawing information. The first projection is a default projection of the browser. The method further includes un-projecting, via the computing device, the first visual guide to reverse the first projection of the browser. The un-projected first visual guide is a second visual guide for the 3D object. The method further includes projecting, via the computing device, the second visual guide according to an actual 3D location of the 3D object in the computerized 3D space. The actual 3D location is different from the default 3D location. The method further includes displaying, in the browser, the second visual guide at the actual 3D location at which the 3D drawing will appear subsequent to displaying the 3D object in the browser. That is, the second visual guide indicates the actual 3D location of the 3D object after the browser performs a perspective calculation on the 3D object to project the 3D object. For the second visual guide to indicate the actual 3D location of the 3D object after the browser performs the perspective calculation on the 3D object, the first visual guide, which is typically user specified, is un-projected from the default projection of the browser. Points of the first visual guide are un-projected, and thereafter projected by the browser so that the actual 3D location of the 3D object may be indicated by the second visual guide. That is, the first visual guide shows the default 3D location of the 3D object, which is a location of the 3D object before the browser projects the 3D object, which will be created and displayed. The second visual guide shows the actual 3D location of the 3D object after projection of the 3D object has been performed by the browser.

According to another embodiment, a non-transitory computer-readable storage medium comprising instructions for displaying a corrected browser projection of a visual guide for placing a three dimensional (3D) object displayed by a browser, the instructions for controlling a computer system to be operable for: receiving drawing information for displaying the 3D object in the browser, and displaying, in the browser, a first visual guide having a first projection for the 3D object for a default 3D location in a computerized 3D space in response to receiving the drawing information, wherein the first projection is a default projection of the browser; un-projecting the first visual guide to reverse the first projection of the browser, wherein the un-projected first visual guide is a second visual guide for the 3D object; projecting the second visual guide according to an actual 3D location of the 3D object in the computerized 3D space, wherein the actual 3D location is different from the default 3D location; and displaying, in the browser, the second visual guide at the actual 3D location at which the 3D drawing will appear subsequent to displaying the 3D object in the browser.

According to another embodiment, an apparatus configured to display corrected browser projection of a visual guide for placing a 3D object displayed by a browser includes a set of computer processors; and a computer-readable storage medium comprising instructions for controlling the set of computer processors to be operable for: receiving drawing information for displaying the 3D object in the browser; displaying, in the browser, a first visual guide having a first projection for the 3D object for a default 3D location in a computerized 3D space in response to receiving the drawing information, wherein the first projection is a default projection of the browser; un-projecting the first visual guide to reverse the first projection of the browser, wherein the un-projected first visual guide is a second visual guide for the 3D object; projecting the second visual guide according to an actual 3D location of the 3D object in the computerized 3D space, wherein the actual 3D location is different from the default 3D location; and displaying, in the browser, the second visual guide at the actual 3D location at which the 3D drawing will appear subsequent to displaying the 3D object in the browser. The following portion of the detailed description and the accompanying drawings provide a more detailed understanding of the nature and advantages of the described embodiments.

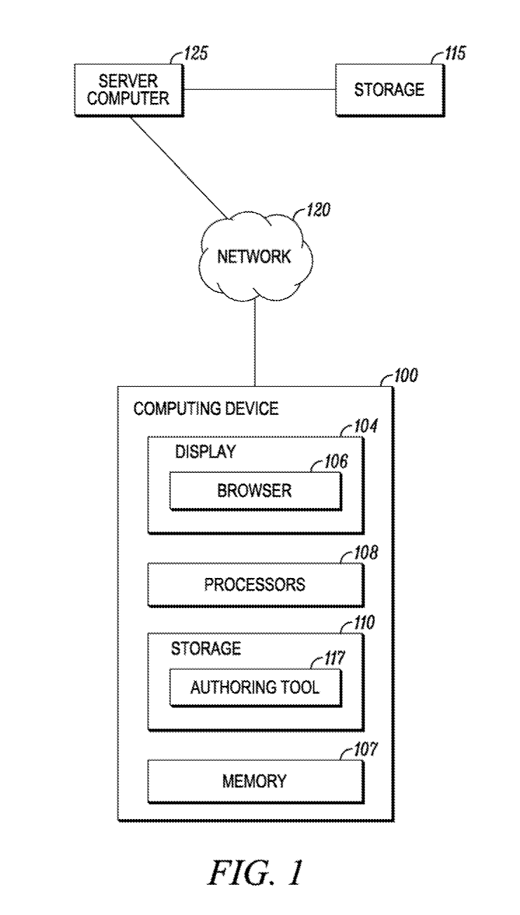

FIG. 1 depicts an example of a computing device 100 for displaying 3D objects according to one embodiment. Computing device 100 includes a display 104 in which a browser 106 is used to display 3D objects. Browser 106 may be a software application that is used to display pages, such as web pages, based on a software code, such as hypertext transfer markup language (HTML) 5 or other languages that can be used to display pages in browser 106. In one embodiment, HTML5 is a universal software programming language that can be used across different computing platforms and environments. Computing device (or a computer) 100 may be any of a variety of devices capable of operating a browser for displaying 3D objects. For example, computing device 100 may be a personal computer (PC), a laptop computer, a table computer, a server computer running a server operating system, a personal digital assistant, a smart phone capable of operating a browser, a game machine capable of operating a browser, etc.

Computing device 100 may include a local memory 107 and a set of processors 108, which is configured to execute software code for software applications. A set as referred to herein includes one or more elements. Computing device 100 may include a storage device 110 or may be configured to receive computer information from a remote storage device 115, which may be coupled to computing device 100 via a network 120. A server computer 125 may be configured to provide computer information from remote storage device 115 to computing device 100. Computer information stored on storage devices 110 and 115 may include software code for software applications and may include various computerized data used by software applications. Storage devices 110 and 115 may be non-transitory storage devices and one or both of these storage devices may be configured to store software code, which embodies various embodiments of the present invention.

Software code stored in storage devices 110 and/or 115 may be for a software application, such as an authoring tool 117, for allowing users to “draw” 3D objects for display of the 3D objects in canvas elements in the browser, which is on display 104. The authoring tool may generate a markup language document, which may be created in local memory and stored in one or both of the storage devices. The markup language document may include instructions for a canvas element and a set 3D objects drawn by a user in a user interface of the authoring tool. The instructions may include markup language instructions (e.g., HTML 5 instructions), scripts (e.g., Java™ scripts), etc. The markup language document may be used by a user for generating web pages or the like where the markup language document for the web page includes the instructions for the canvas element and the set of 3D objects.

Particular embodiments are described immediately below at a generally high level, and are described further below in further detail. The set of processors 108, operating browser 106 and authoring tool 117, displays 3D objects in canvas elements in browser 106 to provide projected views of the 3D objects and projected views of visual guides. A visual guide provides a visual indication to a user as to where a 3D object is to be placed in browser 106. A 3D object may be displayed in a visual guide while the visual guide is created or may be displayed without the visual guide (after the visual guide has been displayed) after a user has selected a location in the browser at which the 3D object is to be placed.

According to one embodiment, authoring tool 117 corrects a default projection of a default visual guide generated by browser 106. A corrected projection of a default visual guide provides that an actual visual guide may be projected and displayed (sometimes referred to as “displayed”) for an actual 3D location of the 3D object and not for a default 3D location, which is used by browser 106 for generating the default projection for the default visual guide.

A default 3D location used by browser 106 for projecting the default visual guide is typically at a selected point in a selected plane where the selected point coincides with the center of the 3D object. That is, the default projection by browser 106 projects the default visual guide as though the 3D object (for which the default visual guide is generated and displayed) has a center in the selected plane. However, the default 3D location of the center of the 3D object may not be the actual 3D location of the center of the 3D object. The selected plane used by browser 106 for default projections is typically the X-Y plane for which the Z coordinate is zero. The X-Y plane as referred to herein is parallel to the plane of display 104 of computing device 100.

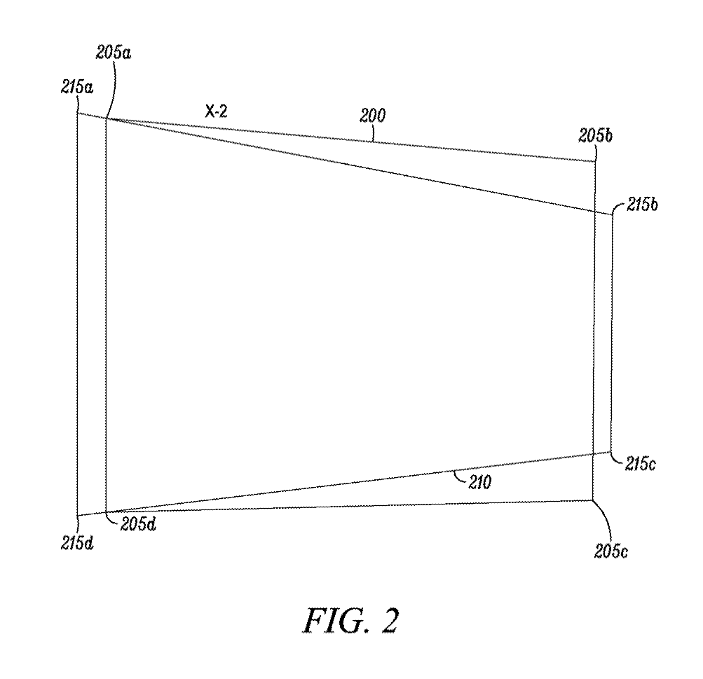

FIG. 2 depicts a computerized 3D space displayed in a canvas element in browser 106 according to one embodiment. The computerized 3D space includes a default visual guide 200 that may be generated by browser 106 operating on computing device 100. Browser 106 operating on computing device 100 creates and displays the default visual guide 200 in response to a user controlling computing device 100 for creating and displaying a 3D object. For example, browser 106 creates and displays default visual guide 200 in response to a cursor being moved (sometimes referred to as being “dragged”) across browser 106. The cursor may be moved in response to a user manipulating the cursor via a mouse, a finger on a touch screen (e.g., of a tablet computer), a touch pad, etc. for which the visual guide identifies to the user the default 3D location at with the 3D object will be displayed. Those of skill in the art will recognize other techniques by which a user may interact with the computing device for directing the computing device to display the default visual guide at a location. Default visual guide 200 may have a rectangular shape or other convenient shape, such as a shape of one of the surfaces of the 3D object for which default visual guide 200 is displayed.

The computerized 3D space depicted in FIG. 2 may also include an actual visual guide 210 where the actual visual guide has an actual projection at that actual 3D location of the center of the 3D object. The actual projection of actual visual guide 210 matches the actual projection of the 3D object for which actual visual guide 210 is generated. Computing device 100 may create and display actual visual guide 210 based at an actual 3D location (i.e., 3D coordinates in computerized 3D space) of the center of the 3D object and not the default 3D location of the center of the 3D object.

It is noted that because the default visual guide has the default projection, the default visual guide may not accurately indicate the location at which the 3D object will be displayed in browser 106 once the 3D object is displayed. Actual visual guide 210 displayed in browser 106 does indicate the location at with the 3D object will be displayed in the browser once the 3D object is displayed.

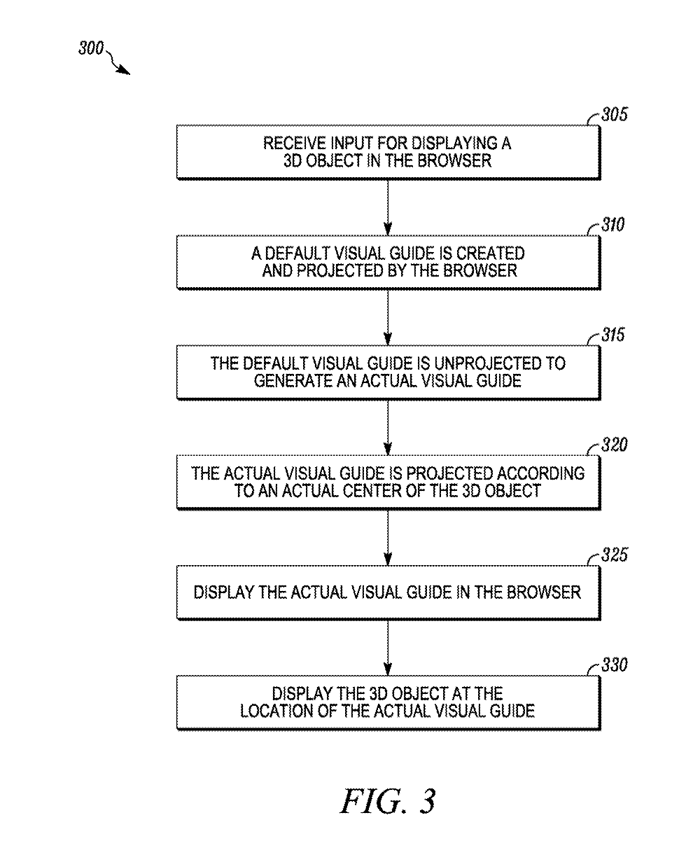

FIG. 3 depicts a simplified flowchart 300 of a method for creating and displaying an actual visual guide 210 for a 3D object according to one embodiment. The simplified flowchart represents an example embodiment and those of skill in the art will understand that various steps shown in the simplified flow chart may be added and/or combined without deviating from the purview of the described embodiment.

At 305, authoring tool 117 receives user input for displaying a 3D object in browser 106. The user input may be received by computing device 100 from one or more of a variety of devices, such a mouse, a touch pad, a touch screen, a keyboard, or the like.

At 310, in response to receiving the user input, browser 106 creates a default visual guide (e.g., default visual guide 200) for the 3D object and displays the default visual guide in browser 106. The user input for creating default visual guide 200 in browser 106 may include shape information and/or location information for default visual guide 200. That is, the default visual guide may have a shape and a location specified by the user input. The user input may be received via authoring tool 117 as the user interacts with authoring tool 117, for example, via the user movement of a cursor (e.g., by a mouse or the like) across browser 106. Referring back to FIG. 2, a set of points 205 (the points are labeled 205a, 205b, 205c, and 205d in FIG. 2) may be specified in the user input for creating the default visual guide. The default visual guide may be created and displayed in browser 106 before the 3D object is created and before the 3D object is projected by a set of projections rules applied by the browser. The default visual guide has the default projection calculated by browser 106. The computerized 3D space in which the default visual guide is displayed may be a canvas element, such as a canvas element of HTML 5.

At 315, authoring tool 117 un-projects the default visual guide to reverse the default projection of browser 106. That is, authoring tool 117 reverses the default projection of browser 106 where browser 106 initially projected the default visual guide with the center of the 3D object in the selected plane (e.g., the X-Y plane with Z equal to zero). Default visual guide 200, subsequent of un-projection, is referred to as actual visual guide 210 for the 3D object.

According to one embodiment, referring back to FIG. 2, a set of points 205 (the points labeled 205a, 205b, 205c, and 205d in FIG. 2) on the default visual guide are un-projected by authoring tool 117 to reverse the default projection of browser 106 to generate a set of un-projected points for an actual visual guide. The set of points 205 and the set of un-projected points are at corresponding locations on default visual guide 200 and the actual visual guide 210. For example, if default visual guide 200 is a rectangle, the set of points 205 may be the corners of the rectangle. Default visual guide 200 as shown in FIG. 2 is shown as a rectangle. The set of un-projected points may similarly be the corners of actual visual guide 210, which may not be a rectangle subsequent to un-projecting the set of points 205. While the set of points 205 is described as including four points for a rectangular shaped default visual guide 200, the set of points 205 may include fewer or more points depending, for example, on alternative shapes (triangular, pentagonal, etc.) of default visual guide 200.

As described above, the set of points 205 of default visual guide 200 are user specified via interaction with authoring tool 117. If the 3D object were to be created based on the set of points 205 and default visual guide 200, browser 106 would apply a projection to the 3D object so that the 3D object would appear at location that is shifted from the boundary (lines between points 205a, 205b, 205c, and 205d) of default visual guide 200. Actual visual guide 210 provides the user visual information for where the 3D object will actually be located in browser 106 after the 3D object is created.

Un-projecting the set of points 205 includes performing the inverse operation on the set of points 205 as compared to the projection operation that is performed on the 3D object when the 3D object is projected by the browser during the creation of the 3D object. The points in the un-projected set of points correspond to the set of points 205 of the default visual guide and define actual visual guide 210. The un-projected set of points of actual visual guide 210 will be non-rectangular, for example, if the default visual guide is rectangular.

At 320, authoring tool 117 projects actual visual guide 210 according to the actual 3D location of the center of the 3D object. For example, the actual 3D location of the center of the 3D object may have coordinates X1, Y1, and Z1 (e.g., where Z1 may be non-zero) whereas the default 3D location of the center of the 3D object may have default coordinates X0, Y0, and Z0 (e.g., where Z1 is zero). Authoring tool 117 projects actual visual guide 210 using the coordinates X1, Y1, and Z1 for the actual 3D location. More specifically, authoring tool 117 may project the set of un-projected points to generate a set of projected points 215 (the points are labeled 215a, 215b, 215c, and 215d in FIG. 2) for actual visual guide 210. Authoring tool 117 may project the set of un-projected points based on the actual 3D location of the center of the 3D object. The projection performed by authoring tool 117 on actual visual guide 210 (the set of un-projected points generated at 315) is the same projection as the projection performed on the 3D object when the 3D object is created.

At 325, subsequent to i) the un-projection of default visual guide 200 to generate the actual visual guide 210 and ii) the projection of actual visual guide 210, authoring tool 117 displays actual visual guide 210 in the browser. Actual visual guide 210 is located at the actual 3D location at which the 3D object will be displayed and actual visual guide 210 has the actual projection that matches the actual projection of the 3D object. Note that in FIG. 2 default visual guide 200 has a different projected shape (2D view on the plane of the page of FIG. 2) compared to actual visual guide 210 where the different shape of actual visual guide 210 is a result of actual visual guide 210 having the actual projection that is corrected from the default projection of default visual guide 200 generated by browser 106. Because actual visual guide 210 has the actual projection that matches the projection of the 3D object, actual visual guide 210 informs a user of where the 3D object will be placed in browser 106 when the 3D object is displayed. Note that if a user placed (e.g., dragging out default visual guide 200) default visual guide 200 and expected the 3D object to be placed in browser 106 at the location of default visual guide 200, the user would see that the 3D object would not be placed according to default visual guide 200. For example, if the 3D object is a box, a front facing side of the box would not have a shape that matches default visual guide 200, but would have a shape that matches actual visual guide 210. A user placing the box 3D object using default visual guide 200 would find it difficult to place the box 3D object at a desired location because the location of default visual guide 200 does not match the location at which the box 3D object (or any other 3D object) will be displayed and placement of the box 3D object is unknown.

At 330, authoring tool 117 creates and projects the 3D object, and displays the 3D object in the location of actual visual guide 210 in browser 106. After the 3D object is displayed, default visual guide 200 and actual visual guide 210 may be removed from browser 106.

According to one embodiment, authoring tool 117 may generate a markup language document in local memory where the markup language document includes instructions (markup language instructions, scripts, etc.) for a canvas element for default visual guide 200, actual visual guide 210, and the 3D object. The markup language document may also include instructions for the 3D object so that the 3D object may be rendered in the canvas element. The markup language document may be stored in one of the storage devices for later interpretation by browser 106 or for use by a web developer to develop web pages that include the 3D object.

According to one embodiment, authoring tool 117 makes an adjustment to the location of actual visual guide 210 to aid a user in positioning a 3D object. For example, authoring tool 117 may move actual visual guide 210 to align a side or a point of actual visual guide 210 with another 3D object displayed in browser 106. By authoring tool 117 moving actual visual guide 210 to align a side or a point of actual visual guide 210 with another 3D object, 3D objects that are intended to touch can be placed relatively quickly and accurately. According to an alternative embodiment, actual visual guide 210 may be moved by a user, for example, by controlling the movement of a cursor placed on actual visual guide 210.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method operable on a computing device for displaying a corrected browser projection of a visual guide for placing a three dimensional (3D) object displayed by a browser, the method comprising:
receiving, via the computing device, drawing information for displaying the 3D object in the browser;
displaying, in the browser, a first visual guide having a first projection for the 3D object for a default 3D location in a computerized 3D space in response to receiving the drawing information, wherein the first projection is a default projection of the browser;
un-projecting, via the computing device, the first visual guide to reverse the first projection of the browser, wherein the un-projected first visual guide is a second visual guide for the 3D object;
projecting, via the computing device, the second visual guide according to an actual 3D location of the 3D object in the computerized 3D space, wherein the actual 3D location is different from the default 3D location; and
displaying, in the browser, the second visual guide at the actual 3D location at which the 3D drawing will appear subsequent to displaying the 3D object in the browser.

2. The method of claim 1, further comprising displaying, in the browser, the 3D object at the actual 3D location.

3. The method of claim 2, wherein displaying the 3D object at the actual 3D location includes displaying the 3D object with a projection that is the same as the projection for the second visual guide.

4. The method of claim 2, further comprising removing the first visual guide and the second visual guide from the browser subsequent to displaying the 3D object at the actual 3D location.

5. The method of claim 1, further comprising displaying in the browser the 3D object in the second visual guide.

6. The method of claim 1, further comprising receiving, via the computing device, a command for moving the second visual guide to a different 3D location; and displaying the 3D object at the different 3D location, wherein the 3D object is not moved by the browser from the different 3D location when the 3D object is displayed.

7. The method of claim 6, wherein receiving the command for moving the second visual guide to the different 3D location includes receiving, via the computing device, the command from a user.

8. The method of claim 1, wherein un-projecting includes un-projecting a set of points on the first visual guide.

9. The method of claim 8, wherein the set of points are at corners of the first visual guide.

10. The method of claim 9, wherein projecting the second visual guide includes projecting the set of points to a second set of points, which are at corners of the second visual guide.

11. A non-transitory computer-readable storage medium comprising instructions for displaying a visual guide for placing a corrected browser projection of a three dimensional (3D) object displayed by a browser, the instructions for controlling a computer system to be operable for:
receiving drawing information for displaying the 3D object in the browser;
displaying, in the browser, a first visual guide having a first projection for the 3D object for a default 3D location in a computerized 3D space in response to receiving the drawing information, wherein the first projection is a default projection of the browser;
un-projecting the first visual guide to reverse the first projection of the browser, wherein the un-projected first visual guide is a second visual guide for the 3D object;
projecting the second visual guide according to an actual 3D location of the 3D object in the computerized 3D space, wherein the actual 3D location is different from the default 3D location; and
displaying, in the browser, the second visual guide at the actual 3D location at which the 3D drawing will appear subsequent to displaying the 3D object in the browser.

12. The non-transitory computer-readable storage medium containing of claim 11, wherein displaying the 3D object at the actual 3D location includes displaying the 3D object with a projection that is the same as the projection for the second visual guide.

13. The non-transitory computer-readable storage medium containing of claim 12, wherein the instructions are further configured for controlling a computer system to be operable for removing the first visual guide and the second visual guide from the browser subsequent to displaying the 3D object at the actual 3D location.

14. The non-transitory computer-readable storage medium containing of claim 11, wherein un-projecting includes un-projecting a set of points on the first visual guide.

15. The non-transitory computer-readable storage medium containing of claim 14, wherein the set of points are at corners of the first visual guide.

16. The non-transitory computer-readable storage medium containing of claim 15, wherein projecting the second visual guide includes projecting the set of points to a second set of points, which are at corners of the second visual guide.

17. An apparatus configured to display corrected browser projection of a visual guide for placing a three dimensional (3D) object displayed by a browser, the apparatus comprising:
a set of computer processors; and
a computer-readable storage medium comprising instructions for controlling the set of computer processors to be operable for:
receiving drawing information for displaying the 3D object in the browser;
displaying, in the browser, a first visual guide having a first projection for the 3D object for a default 3D location in a computerized 3D space in response to receiving the drawing information, wherein the first projection is a default projection of the browser;
un-projecting the first visual guide to reverse the first projection of the browser, wherein the un-projected first visual guide is a second visual guide for the 3D object;
projecting the second visual guide according to an actual 3D location of the 3D object in the computerized 3D space, wherein the actual 3D location is different from the default 3D location; and
displaying, in the browser, the second visual guide at the actual 3D location at which the 3D drawing will appear subsequent to displaying the 3D object in the browser.

18. The apparatus of claim 17, wherein rending the 3D object at the actual 3D location comprises displaying the 3D object with a projection that is the same as the projection for the second visual guide.

19. The apparatus of claim 17, wherein rending the 3D object at the actual 3D location comprises removing the first visual guide and the second visual guide from the browser subsequent to displaying the 3D object at the actual 3D location.

20. The apparatus of claim 17, wherein un-projecting comprises:
un-projecting a set of points on the first visual guide, wherein the set of points are at corners of the first visual guide; and
projecting the set of points to a second set of points, which are at corners of the second visual guide.
